(19) United States
(12) Patent Application Publication
(10) Pub. No.: US 2021/0298129 A1
(43) Pub. Date: Sep. 23, 2021

(54) HEATER AND ARTICLE EQUIPPED WITH HEATER

(71) Applicant: NITTO DENKO CORPORATION, Ibaraki-shi, Osaka (JP)

(72) Inventors: Yosuke Nakanishi, Osaka (JP); Toshihiro Tsurusawa, Osaka (JP); Takeshi Tanaka, Osaka (JP); Kyotaro Yamada, Osaka (JP); Hironobu Machinaga, Osaka (JP); Shu Sasaki, Osaka (JP); Tetsuro Hori, Osaka (JP)

(73) Assignee: NITTO DENKO CORPORATION, Ibaraki-shi, Osaka (JP)

(21) Appl. No.: 17/260,313

(22) PCT Filed: Jul. 23, 2019
(86) PCT No.: PCT/JP2019/028903

§ 371 Date: Jan. 14, 2021

(30) Foreign Application Priority Data
Aug. 2, 2018 (JP) 2018-145551

(51) Int. Cl. H05B 3/34; H05B 3/03; H05B 3/14

(52) U.S. Cl. CPC H05B 3/34; H05B 3/03; H05B 2203/016; H05B 2203/013; H05B 3/141

(57) ABSTRACT

A heater (1a) includes a substrate (10), a transparent conductive oxide layer (20), a first power supply electrode (31), and a second power supply electrode (32). The ratio of the sum of the electric resistance of the first power supply electrode (31) in a particular direction and the electric resistance of the second power supply electrode (32) in the particular direction to the electric resistance of the transparent conductive oxide layer (20) between the first power supply electrode (31) and the second power supply electrode (32) is 45% or less. The transparent conductive oxide layer (20) has a thickness from 20 to 250 nm and is formed of a material having a specific resistance from 1.4×10⁻⁴ to 3.0×10⁻⁴ Ω·cm.

### TECHNICAL FIELD

The present invention relates to a heater and an article equipped with a heater (also referred to as “heater-equipped article” hereinafter).

### BACKGROUND ART

Planar heaters in which a thin film of a transparent conductive oxide such as indium tin oxide (ITO) is used have been conventionally known.

For example, Patent Literature 1 discloses a heater panel that includes a film-shaped flexible substrate, a transparent thin film conductive layer in the form of a single layer of a material such as ITO, and two bar electrodes. In this heater panel, the transparent thin film conductive layer adheres to a surface of the substrate. The two bar electrodes are disposed on the transparent thin film conductive layer. The bar electrodes are formed by printing such as screen printing. Printable conductive inks are thus suitable for forming the bar electrodes. A useful conductive ink contains silver particles in an epoxy binder.

Patent Literature 2 discloses a transparent planar heater that includes a transparent substrate, a transparent conductive thin film, and electrodes. As the material of the transparent substrate, a polymer resin such as a polyester resin is used. The transparent conductive thin film is a metal thin film or a semiconductor thin film, and the material of the semiconductor thin film may be In₂O₃, SnO₂, or ITO. The electrodes are formed in both end portions of the transparent conductive thin film. The electrodes each include conductive resin layers and a conductive metal foil. One of the conductive resin layers is formed on the transparent conductive thin film by printing or coating. The conductive metal foil is provided on this conductive resin layer. The other conductive resin layer is further laminated on the conductive metal foil.

### CITATION LIST

### Patent Literatures

Patent Literature 1: U.S. Pat. No. 4,952,783
Patent Literature 2: JP 4(1992)-289685 A

### SUMMARY OF INVENTION

### Technical Problem

The electrodes used in the heaters disclosed in Patent Literatures 1 and 2 have room for improvement from the viewpoint of increasing the amount of heat generation achieved by the heaters and suppressing uneven spatial distribution of the amount of heat generation in heating elements.

In light of the foregoing, the present invention provides a heater that is configured such that a pair of power supply electrodes are electrically connected to a transparent conductive oxide layer and is advantageous from the viewpoint of achieving a large amount of heat generation and suppressing uneven spatial distribution of the amount of heat generation in a heating element.

### Solution to Problem

The present invention provides a heater including: a substrate; a transparent conductive oxide layer that is disposed on the substrate; a first power supply electrode that is electrically connected to the transparent conductive oxide layer and extends in a particular direction; and a second power supply electrode that is electrically connected to the transparent conductive oxide layer and extends in the particular direction while being spaced apart from the first power supply electrode, wherein a ratio of a sum of an electric resistance of the first power supply electrode in the particular direction and an electric resistance of the second power supply electrode in the particular direction to an electric resistance of the transparent conductive oxide layer between the first power supply electrode and the second power supply electrode is 45% or less, and the transparent conductive oxide layer has a thickness from 20 to 250 nm and is formed of a material having a specific resistance from 1.4×10⁻⁴ to 3.0×10⁻⁴ Ω·cm.

### Advantageous Effects of Invention

The above-described heater is advantageous from the viewpoint of achieving a large amount of heat generation and suppressing uneven spatial distribution of the amount of heat generation in a heating element while the heater is configured such that the first power supply electrode and the second power supply electrode are electrically connected to the transparent conductive oxide layer.

### BRIEF DESCRIPTION OF DRAWINGS

FIG. 1A is a plan view showing an example of the heater according to the present invention.

FIG. 1B is a cross-sectional view of the heater taken along line IB-IB in FIG. 1A.

FIG. 2 is a cross-sectional view showing another example of the heater according to the present invention.

FIG. 3 is a cross-sectional view showing an example of a heater-equipped article according to the present invention.

### DESCRIPTION OF EMBODIMENTS

The inventors of the present invention conducted in-depth studies on a heater provided with a transparent conductive oxide layer, and they developed the heater according to the present invention on the basis of the following new findings.

The electrodes used in the heater disclosed in Patent Literature 1 are formed using a conductive ink, and it is considered that the electric resistances of these electrodes in the longitudinal direction are higher than those of electrodes formed of metal materials in the longitudinal direction. In the heater disclosed in Patent Literature 1, end portions of the electrodes in the longitudinal direction are connected to a power supply. Since the electric resistances of the electrodes in the longitudinal direction are relatively high, it is considered that the magnitude of a current flowing through the transparent thin film conductive layer differs greatly between portions of the transparent thin film conductive layer near the end portions of the electrodes connected to the power supply and portions of the transparent thin film conductive layer away from these end portions of the electrodes. Accordingly, the amount of heat generation differs greatly between the portions of the transparent thin film conductive layer near the end portions of the electrodes connected to the power supply and the portions of the transparent thin film conductive layer away from these end portions of the electrodes, resulting in uneven spatial distribution of the amount of heat generation in the heater. In addition, when the electrodes are formed using a conductive ink, the electric resistance of the circuit as a whole tends to be high, which makes it difficult to increase the amount of heat generation achieved by the heater. Moreover, it is considered that the electrodes formed using a conductive ink is likely to peel off. According to the technique disclosed in Patent Literature 2, it is considered that the conductive metal foils serve to reduce the electric resistances of the electrodes in the longitudinal direction. However, the electrodes of the heater disclosed in Patent Document 2 each also include the conductive resin layer. Accordingly, the technique disclosed in Patent Literature 2 still has room for further reduction of the electric resistances of the electrodes in the longitudinal direction.

In order to reduce the electric resistance of a heating element solely by using a conventional transparent conductive oxide layer, the transparent conductive oxide layer needs to have a considerably large thickness. However, the transparent conductive oxide layer having a large thickness is likely to crack.

In light of the foregoing, the inventors conducted in-depth studies to develop a heater capable of achieving a large amount of heat generation and suppressing uneven spatial distribution of the amount of heat generation in a heating element while the heater is configured such that a pair of power supply electrodes are electrically connected to a transparent conductive oxide layer. After much trial and error, the inventors fundamentally reconsidered the conditions for producing a transparent conductive oxide layer, and finally succeeded in reducing the specific resistance of a material forming the transparent conductive oxide layer. This allowed the electric resistance of a heating element to be reduced while keeping the thickness of the transparent conductive oxide layer small. Moreover, on the precondition that such a transparent conductive oxide layer is used, the inventors conducted further studies to find out a desirable relationship between the electric resistance of the electrodes and the electric resistance of the transparent conductive oxide layer from the viewpoint of suppressing uneven spatial distribution of the amount of heat generation.

Hereinafter, embodiments of the present invention will be described with reference to the drawings. The following embodiments describe merely illustrative implementation of the present invention, and the present invention is not limited to the following embodiments.

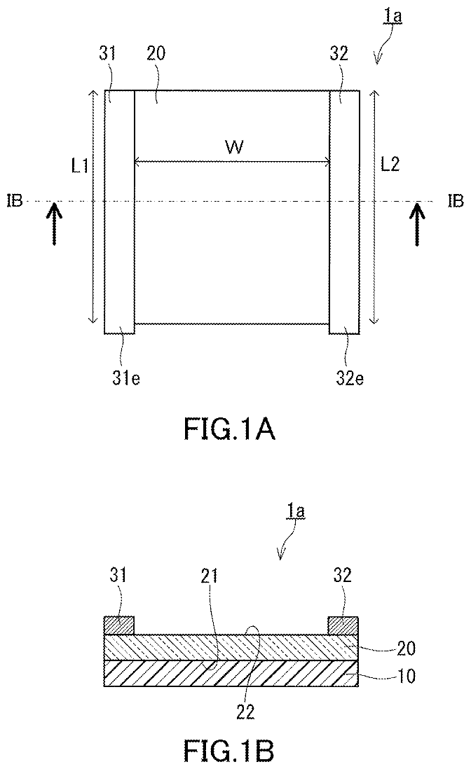

As shown in FIGS. 1A and 1B, a heater 1a includes a substrate 10, a transparent conductive oxide layer 20, a first power supply electrode 31, and a second power supply electrode 32. The transparent conductive oxide layer 20 is disposed on the substrate 10. The substrate 10 is typically in contact with a principal surface 21 (first principal surface) of the transparent conductive oxide layer 20. In the heater 1a, the transparent conductive oxide layer 20 functions as a heating element. The first power supply electrode 31 is electrically connected to the transparent conductive oxide layer 20 and extends in a particular direction. The first power supply electrode 31 has an elongated shape with a maximum dimension in the particular direction. The second power supply electrode 32 is electrically connected to the transparent conductive oxide layer 20 and extends in the particular direction while being spaced apart from the first power supply electrode 31. In other words, on a second principal surface 22, the second power supply electrode 32 extends in parallel with the first power supply electrode 31. The second power supply electrode 32 has an elongated shape with a maximum dimension in the particular direction. The ratio (Rₑ₁+Rₑ₂)/R_{H} of the sum (Rₑ₁+Rₑ₂) of the electric resistance Rₑ₁ of the first power supply electrode 31 in the particular direction and the electric resistance Rₑ₂ of the second power supply electrode 32 in the particular direction to the electric resistance R_{H} of the transparent conductive oxide layer 20 between the first power supply electrode 31 and the second power supply electrode 32 is 45% or less. In addition, the transparent conductive oxide layer 20 has a thickness from 20 to 250 nm and is formed of a material having a specific resistance from 1.4×10⁻⁴ to 3.0×10⁻⁴ Ω·cm.

Wiring (not shown) for electrically connecting the heater 1a to a power supply is attached to the first power supply electrode 31 and the second power supply electrode 32. The positions at which the wiring is attached are not particularly limited as long as desired electric power can be supplied to the heater 1a. This wiring may be attached on either the same side or different sides of the first power supply electrode 31 and the second power supply electrode 32 in the thickness direction. For example, this wiring is attached to an end portion 31e of the first power supply electrode 31 in the particular direction and an end portion 32e of the 5 second power supply electrode 32 in the particular direction. The end portions 31e and 32e are on the same side of the heater 1a in the particular direction. Alternatively, the end portions 31e and 32e may be on different sides of the heater 1a in the particular direction.

The transparent conductive oxide layer 20 is formed of a material having a low specific resistance as described above, and this allows the heater 1a to achieve a large amount of heat generation. In addition, the heater 1a can achieve a large amount of heat generation even though the transparent conductive oxide layer 20 has a small thickness from 20 to 250 nm. The transparent conductive oxide layer 20 having a small thickness from 20 to 250 nm is less likely to crack. Since (Rₑ₁+Rₑ₂)/R_{H} is 45% or less, Rₑ₁+Rₑ₂ is smaller than R_{H}. With this configuration, uneven spatial distribution of the amount of heat generation in the heating element can be suppressed. (Rₑ₁+Rₑ₂)/R_{H} may be 35% or less, or may be 25% or less.

The transparent conductive oxide layer 20 may be formed of a material having a specific resistance from 1.5×10⁻⁴ to 2.9×10⁻⁴ Ω·cm, or may be formed of a material having a specific resistance from 1.6×10⁻⁴ to 2.8×10⁻⁴ Ω·cm.

The thickness of the transparent conductive oxide layer 20 may be from 30 to 230 nm, or may be from 40 to 200 nm.

For example, the material forming the first power supply electrode 31 has a specific resistance of 4×10⁻⁵ Ω·m or less, and the material forming the second power supply electrode 32 has a specific resistance of 4×10⁻⁵ Ω·m or less. This configuration is advantageous from the viewpoint of satisfying the relationship of (Rₑ₁+Rₑ₂)/Ra 45%. The material forming the first power supply electrode 31 may have a specific resistance of 8×10⁻⁶ Ω·m or less, or the material forming the first power supply electrode 31 may have a specific resistance of 6×10⁻⁶ Ω·m or less. The material forming the second power supply electrode 32 may have a specific resistance of 8×10⁻⁶ Ω·m or less, or the material forming the second power supply electrode 32 may have a specific resistance of 6×10⁻⁶ Ω·m or less.

For example, the material forming the first power supply electrode 31 is a metal material, and the material forming the second power supply electrode 32 is a metal material. This configuration is advantageous from the viewpoint of satisfying the relationship of (Rₑ₁+Rₑ₂)/R_{H}≤45%. The metal material may be a single element metal such as copper, or may be an alloy such as stainless steel. Each of the first power supply electrode 31 and the second power supply electrode 32 may be formed of a single metal material or a plurality of metal materials.

For example, the first power supply electrode 31 has a thickness of 1 μm or more, and the second power supply electrode 32 has a thickness of 1 μm or more. This is advantageous from the viewpoint of satisfying the relationship of (Rₑ₁+Rₑ₂)/R_{H}≤45%. Besides, the first power supply electrode 31 and the second power supply electrode 32 are less likely to be damaged when the heater 1a is operated at a high temperature rise rate. The power supply electrodes 30 are much thicker than electrodes formed on a transparent conductive film used in display devices such as a touch panel. The thickness of the first power supply electrode 31 may be 2 μm or more, 3 μm or more, or 5 μm or more. The thickness of the first power supply electrode 31 may be, for example, 200 μm or less, 150 μm or less, or 100 μm or less. The thickness of the second power supply electrode 31 may be 2 μm or more, 3 μm or more, or 5 μm or more. The thickness of the second power supply electrode 32 may be, for example, 200 μm or less, 150 μm or less, or 100 μm or less.

The material forming the transparent conductive oxide layer 20 contains, for example, indium oxide as a main component. The term “main component” as used herein refers to a component whose content on a mass basis is the highest. The material forming the transparent conductive oxide layer 20 is desirably indium tin oxide (ITO). The content of tin oxide in ITO is, for example, 4 to 14 mass %, and desirably 5 to 13 mass %. ITO forming the transparent conductive oxide layer 20 preferably has a polycrystalline structure. This is advantageous from the viewpoint of keeping the specific resistance of the transparent conductive oxide layer 20 low.

The carrier density of the transparent conductive oxide layer 20 as determined by Hall effect measurement is, for example, 6.0×10²⁰ cm⁻³ or more. The Hall effect measurement is performed according to the van der Pauw method, for example. When the transparent conductive oxide layer 20 has such a high carrier density, the specific resistance of the material forming the transparent conductive oxide layer 20 can be easily adjusted to fall within the above range. This allows the heater 1a to easily achieve a large amount of heat generation.

The carrier density of the transparent conductive oxide layer 20 is desirably 7.0×10²⁰ cm⁻³ or more, and more desirably 7.5×10²⁰ cm⁻³ or more. The carrier density of the transparent conductive oxide layer 20 is, for example, 16×10²⁰ cm⁻³ or less.

In the heater 1a, the Hall mobility of the transparent conductive oxide layer 20 is, for example, 15 cm²/(V·s) or more. This allows the specific resistance of the material forming the transparent conductive oxide layer 20 to be easily adjusted to fall within the above range. Accordingly, the heater 1a can easily achieve a large amount of heat generation.

The Hall mobility of the transparent conductive oxide layer 20 is desirably 10 cm²/(V·s) or more, and more desirably 12 cm²/(V·s) or more. The Hall mobility of the transparent conductive oxide layer 20 is, for example, 50 cm²/(V·s) or less.

The substrate 10 is flexible, for example. In this case, the material of the substrate 10 is not particularly limited as long as the material is flexible. For example, the substrate 10 is made of an organic polymer. The substrate 10 is made of at least one selected from the group consisting of polyethylene terephthalates, polyethylene naphthalates, polyimides, polycarbonates, polyether ether ketones, and aromatic polyamides, for example. The substrate 10 may be a flexible sheet glass.

The thickness of the substrate 10 is not limited to a particular thickness. From the viewpoint of favorable transparency, favorable strength, and ease of handling, the thickness of the substrate 10 is from 10 μm to 200 μm, for example. The thickness of the substrate 10 may be from 15 μm to 180 μm, or may be from 20 μm to 160 μm.

The substrate 10 may include a functional layer such as a hard coat layer, a stress buffer layer, or an optical adjustment layer. Each of these functional layers constitutes, for example, one principal surface of the substrate 10 in contact with the transparent conductive oxide layer 20. Each of these functional layers can serve as a base of the transparent conductive oxide layer 20.

The transparent conductive oxide layer 20 is not particularly limited, and is obtained by, for example, performing sputtering using a target material containing indium oxide as a main component to form a thin film derived from the target material on one principal surface of the substrate 10. The thin film derived from the target material is formed on one principal surface of the substrate 10 desirably by high magnetic field DC magnetron sputtering. In this case, the transparent conductive oxide layer 20 can be formed at low temperatures. Accordingly, for example, even when the heat resistant temperature of the substrate 10 is not high, the transparent conductive oxide layer 20 can be formed on the substrate 10. In addition, defects are less likely to occur in the transparent conductive oxide layer 20, and a low internal stress of the transparent conductive oxide layer 20 can be achieved more easily. Also, by adjusting the conditions for sputtering, a thin film that is desirable as the transparent thin film conductive layer 20 can be formed easily. For example, by adjusting the horizontal magnetic field on a surface of a target material to a predetermined value in high magnetic field DC magnetron sputtering, the Hall mobility of the transparent conductive oxide layer 20 is increased, thereby allowing the transparent conductive oxide layer 20 desirable in terms of specific resistance to be obtained easily.

The thin film formed on one principal surface of the substrate 10 is subjected to annealing, when necessary. For example, the thin film is annealed by being placed in the air at 120° C. to 150° C. for 1 to 3 hours. This facilitates crystallization of the thin film, whereby the transparent conductive oxide layer 20 that is polycrystalline is formed advantageously. When the temperature of the environment in which the annealing treatment of the thin film is performed and the time period for performing the annealing treatment are within the above-described ranges, the heat resistant temperature of the substrate 10 need not necessarily be high, and an organic polymer can be used as the material of the substrate 10. In addition, defects are less likely to occur in the transparent conductive oxide layer 20, and a low internal stress of the transparent conductive oxide layer 20 can be achieved more easily. By adjusting the conditions for the annealing treatment, the transparent conductive oxide layer 20 desirable in terms of specific resistance can be obtained easily. For example, by limiting the amount of oxygen supplied during the annealing treatment within a predetermined range, a polycrystalline transparent conductive oxide layer having a high carrier density can be obtained easily. Accordingly, the specific resistance of the transparent conductive oxide layer 20 can be easily adjusted to fall within a desired range.

The first power supply electrode 31 and the second power supply electrode 32 are produced in the following manner, for example. A masking film is placed so as to partially cover the second principal surface 22 of the transparent conductive oxide layer 20. When another film is laminated on the second principal surface 22 of the transparent conductive oxide layer 20, the masking film may be placed on this film. In this state, a metal film with a thickness of 1 μm or more is formed on exposed portions of the transparent conductive oxide layer 20 and on the masking film by a dry process such as chemical vapor deposition (CVD) or physical vapor deposition (PVD) or by a wet process such as plating. Thereafter, by removing the masking film, portions of the metal film remain in the exposed portions of the transparent conductive oxide layer 20, whereby the first power supply electrode 31 and the second power supply electrode 32 can be formed. Alternatively, the first power supply electrode 31 and the second power supply electrode 32 may be formed by forming a metal film with a thickness of 1 μm or more on the second principal surface 22 of the transparent conductive oxide layer 20 through a dry process such as CVD or PVD or by a wet process such as plating and then removing unnecessary portions of the metal film by etching.

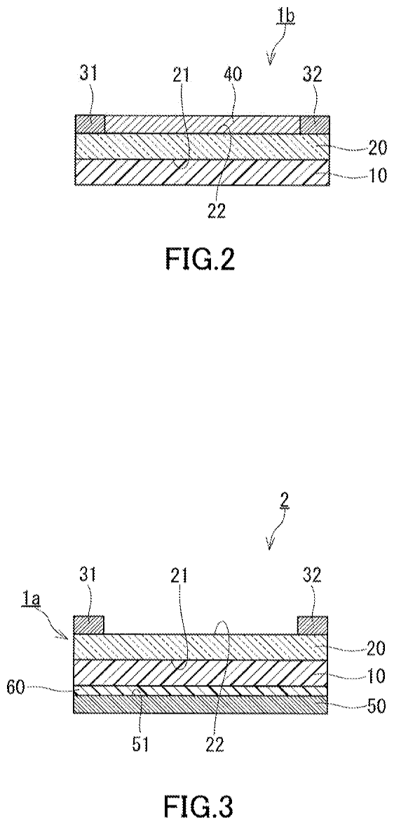

The heater 1a can be modified in various respects. For example, the heater 1a may be modified so as to have the configuration of a heater 1b shown in FIG. 2. Unless otherwise stated, the configurations of the heater 1b is the same as the configuration of the heater 1a. Components of the heater 1b that are the same as or correspond to those of the heater 1a are given the same reference numerals, and detailed descriptions thereof are omitted. The descriptions regarding the heater 1a also apply to the heater 1b, unless technically incompatible.

As shown in FIG. 2, the heater 1b further includes a protective layer 40. The protective layer 40 is disposed closer to a second principal surface 22 of a transparent conductive oxide layer 20 than to a first principal surface 21 of the transparent conductive oxide layer 20. The protective layer 40 includes, for example, a predetermined protective film and a pressure-sensitive adhesive layer for attaching the protective film to the second principal surface 22 of the transparent conductive oxide layer 20. The material forming the transparent conductive oxide layer 20 typically has low toughness. On this account, the transparent conductive oxide layer 20 is protected by the protective film 40, and this allows the heater 1b to have high impact resistance. The material of the protective film included in the protective layer 40 is not particularly limited, and may be, for example, a synthetic resin such as a fluororesin, silicone, an acrylic resin, or polyester. The thickness of the protective film is not particularly limited, and is, for example, from 20 μm to 200 μm. This can prevent the heater 1b from having an excessively large thickness while maintaining favorable impact resistance. The pressure-sensitive adhesive layer is formed of a known pressure-sensitive adhesive such as an acrylic pressure-sensitive adhesive, for example.

A heater-equipped article can be produced using the heater 1a. For example, as shown in FIG. 3, a heater-equipped article 2 includes a molded body 50, a pressure-sensitive adhesive layer 60, and the heater 1a. The molded body 50 has an adherend surface (surface to be subjected to adhesion) 51. The molded body 50 is formed of a metal material or a synthetic resin. The pressure-sensitive adhesive layer 60 is in contact with the adherend surface 51. The pressure-sensitive adhesive layer 60 is formed of a known pressure-sensitive adhesive such as an acrylic pressure-sensitive adhesive, for example. The heater 1a is in contact with the pressure-sensitive adhesive layer 60 and is attached to the molded body 50 with the pressure-sensitive adhesive body 60.

The adhesive layer 60 may be formed beforehand on, for example, a principal surface of the substrate 10 of the heater 1a on the side opposite to a principal surface of the same in contact with the transparent conductive oxide layer 20. In this case, the heater 1a can be attached to the molded body 50 by pressing the heater 1a against the molded body 50 in the state where the pressure-sensitive adhesive layer 60 and the adherend surface 51 face each other. The pressure-sensitive adhesive layer 60 may be covered with a separator (not shown). In this case, the separator is peeled off at the time of attaching the heater 1a to the molded body 50 to expose the pressure-sensitive adhesive layer 60. The separator 60 is, for example, a film made of a polyester resin such as polyethylene terephthalate (PET).

For example, in an apparatus configured to execute processing using near-infrared light, the heater 1a is disposed on the optical path of this near-infrared light. This apparatus executes predetermined processing such as sensing or communication using near-infrared light, for example. The molded body 50 constitutes, for example, a housing of such an apparatus.

### EXAMPLES

Hereinafter, the present invention will be described in more detail with reference to examples. The present invention is not limited to the following examples. First, evaluation methods and measurement methods used in the examples and comparative examples will be described.

[Thickness Measurement]

The thickness of a transparent conductive oxide layer (heating element) of a heater according to each of the examples and comparative examples was measured by X-ray reflectometry using an X-ray diffractometer (Rigaku Corporation, product name: RINT 2200). The results are shown in Table 1. Also, the X-ray diffraction pattern of the transparent conductive oxide layer was obtained using the X-ray diffractometer. The X-rays used in the measurement were Cu-Kα X-rays. From the X-ray diffraction patterns obtained, it was confirmed that the transparent conductive oxide layers according to the respective examples had a polycrystalline structure. Also, the thickness of each power supply electrode of the heater according to each of the examples and comparative examples was measured by measuring the height of an end portion of the power supply electrode of the heater according to each of the examples and comparative examples using a stylus surface profiler (ULVAC, Inc., product name: Dektak 8). The results are shown in Table 1.

[Sheet Resistance, Specific Resistance, and Electric Resistance]

The sheet resistance of the transparent conductive oxide layer (heating element) of the heater according to each of the examples and comparative examples was measured in accordance with the Japanese Industrial Standard (JIS) Z 2316: 2014 by an eddy current method using a non-contact type resistance measurement instrument (Napson Corporation, product name: NC-80MAP). The results are shown in Table 1. In addition, the specific resistance of the transparent conductive oxide layer (heating element) of the heater according to each of the examples and comparative examples was determined by calculating the product of the thickness of the transparent conductive oxide layer (heating element) obtained by the thickness measurement and the sheet resistance of the transparent conductive oxide layer (heating element). The results are shown in Table 1. The specific resistances of the power supply electrodes shown in Table 1 are values based on the descriptions in literatures or specifications. The sum of the electric resistances (Rₑ₁+Rₑ₂) of the pair of power supply electrodes in the longitudinal direction was determined from the dimensions and the specific resistances of the power supply electrodes. The results are shown in Table 2. In addition, the electric resistance R_{H} of the transparent conductive oxide layer between the pair of power supply electrodes was determined from the sheet resistance of the transparent conductive oxide layer and the distance between the pair of power supply electrodes. The results are shown in Table 2.

[Hall Effect Measurement]

Using a Hall effect measurement system (TOYO Corporation, product name: ResiTest 8400), the transparent conductive oxide layer (heating element) of the heater according to each of the examples and comparative examples was subjected to Hall effect measurement according to the van der Pauw method. From the results of the Hall effect measurement, the carrier density of the transparent conductive oxide layer (heating element) of the heater according to each of the examples and comparative examples was determined. The results are shown in Table 1.

[Heater Properties]

Using a constant voltage DC power supply manufactured by Kikusui Electronics Corp., an energization test was performed by applying a voltage of 12 V to the pair of power supply electrodes of the heater according to each of the examples and comparative examples to cause a current to flow through the transparent conductive oxide layer (heating element) of the heater. Wiring for connecting the heater to the power supply is attached to end portions of the respective power supply electrodes on the same side in the longitudinal direction. During the energization test, the surface temperature of the transparent conductive oxide layer (heating element) was measured using a thermograph manufactured by FLIR Systems, Inc., and the temperature rise rate was calculated. The highest value and the lowest value of the temperature rise rate on the surface obtained as a result of the measurement are shown in Table 2.

[Crack Resistance]

A film having the transparent conductive oxide layer of the heater according to each of the examples and comparative examples formed thereon was cut into a rectangular shape of 2 cm×10 cm to prepare a test piece for crack resistance evaluation. The test piece was wrapped around a 25 mm-diameter cylindrical rod along the longitudinal direction of the rod with the transparent conductive oxide layer being on the outside. Then, 112.5 g weights were fixed to both ends of the test piece, and a state where the weights were suspended was kept for 30 seconds. Thereafter, whether the transparent conductive oxide layer cracked was checked through visual observation. The results are shown in Table 2.

### Example 1

An ITO film was formed on one principal surface of a 100 μm thick polyethylene naphthalate (PEN) film (Teijin Film Solutions Limited, product name: TEONEX) by DC magnetron sputtering using indium tin oxide (ITO) (tin oxide content: 10 wt %) as a target material in a high magnetic field with the magnetic flux density of the horizontal magnetic field on the surface of the target material being 100 mT (millitesla) and in the presence of an inert gas. The PEN film with the ITO film formed thereon was heat-annealed by being placed in the air at 150° C. for 3 hours. As a result, ITO was crystallized, whereby a transparent conductive oxide layer was formed. The thickness of the transparent conductive oxide layer was 50 nm.

Next, a strip-shaped section was cut out from the PEN film with the transparent conductive oxide layer formed thereon. Then, the transparent conductive oxide layer was partially covered with a masking film in such a manner that a pair of end portions of the transparent conductive oxide layer facing each other were exposed. The pair of end portions each had a width of 2 mm. In this state, a Cu thin film with a thickness of 100 nm was formed on the transparent conductive oxide layer and on the masking film by DC magnetron sputtering. Further, the Cu thin film was subjected to wet plating to increase the thickness of the Cu film to 20 μm. Thereafter, the masking film was removed, whereby a pair of power supply electrodes (first power supply electrode and second power supply electrode) were formed at portions corresponding to the pair of end portions of the transparent conductive oxide layer. In the above-described manner, a heater according to Example 1 was obtained. The contact surface between each of the power supply electrodes and the transparent conductive oxide layer had a length of 60 mm, and the distance between the pair of power supply electrodes was 20 mm.

### Example 2

A heater according to Example 2 was produced in the same manner as in Example 1, except that the conditions for cutting out a section from a PEN film having a transparent conductive oxide layer formed thereon and for producing power supply electrodes were adjusted such that a contact surface between each power supply electrode and the transparent conductive oxide layer had a length of 100 mm.

### Example 3

A heater according to Example 3 was produced in the same manner as in Example 1, except that the conditions for cutting out a section from a PEN film having a transparent conductive oxide layer formed thereon and for producing power supply electrodes were adjusted such that a contact surface between each power supply electrode and the transparent conductive oxide layer had a length of 500 mm.

### Example 4

A heater according to Example 4 was produced in the same manner as in Example 1, except for the following modifications. The conditions for DC magnetron sputtering for forming an ITO film were adjusted such that a transparent conductive oxide layer had a thickness of 200 nm. The conditions for cutting out a section from a PEN film having the transparent conductive oxide layer formed thereon and for producing power supply electrodes were adjusted such that a contact surface between each power supply electrode and the transparent conductive oxide layer had a length of 100 mm and that the distance between the pair of power supply electrodes was 100 mm.

### Example 5

A heater according to Example 5 was produced in the same manner as in Example 1, except for the following modifications. The conditions for DC magnetron sputtering for forming an ITO film were adjusted such that a transparent conductive oxide layer had a thickness of 35 nm. The conditions for cutting out a section from a PEN film having the transparent conductive oxide layer formed thereon and for producing power supply electrodes were adjusted such that a contact surface between each power supply electrode and the transparent conductive oxide layer had a length of 100 mm.

### Example 6

A heater according to Example 6 was produced in the same manner as in Example 1, except for the following modifications. The conditions for DC magnetron sputtering for forming an ITO film were adjusted such that a transparent conductive oxide layer had a thickness of 120 nm. The conditions for cutting out a section from a PEN film having the transparent conductive oxide layer formed thereon and for producing power supply electrodes were adjusted such that a contact surface between each power supply electrode and the transparent conductive oxide layer had a length of 100 mm.

### Example 7

A heater according to Example 7 was produced in the same manner as in Example 2, except that the conditions for producing power supply electrodes were adjusted such that the power supply electrodes were made of nickel.

### Example 8

A heater according to Example 7 was produced in the same manner as in Example 2, except that the conditions for producing power supply electrodes were adjusted such that the power supply electrodes were made of a SnPb (tin-lead) alloy.

### Example 9

A heater according to Example 9 was produced in the same manner as in Example 2, except that the conditions for producing power supply electrodes were adjusted such that the power supply electrodes had a thickness of 2 μm.

### Comparative Example 1

A heater according to Comparative Example 1 was produced in the same manner as in Example 1, except for the following modifications. A strip-shaped section was cut out from a PEN film having a transparent conductive oxide layer formed thereon. A paste containing silver particles dispersed therein (Fujikura Kasei Co., Ltd., product name: DOTTED-500) was applied onto a pair of end portions of the transparent conductive oxide layer facing each other and was then hardened, whereby a pair of power supply electrodes having a thickness of 20 μm were formed. The contact surface between each power supply electrode and the transparent conductive oxide layer had a length of 100 mm, and the distance between the pair of power supply electrodes was 20 mm.

### Comparative Example 2

A heater according to Comparative Example 2 was produced in the same manner as in Example 1, except for the following modifications. The conditions for producing a transparent conductive oxide layer were adjusted such that the material (ITO) forming the transparent conductive oxide layer had a specific resistance of 8.0×10⁻⁴ Ω·cm. Specifically, the heat annealing was not performed, whereby the transparent conductive oxide layer formed of amorphous ITO was obtained. In addition, the conditions for cutting out a section from a PEN film having the transparent conductive oxide layer formed thereon and for producing power supply electrodes were adjusted such that a contact surface between each power supply electrode and the transparent conductive oxide layer had a length of 100 mm.

### Comparative Example 3

A heater according to Comparative Example 3 was produced in the same manner as in Comparative Example 2, except for the following modifications. The conditions for DC magnetron sputtering were adjusted such that a transparent conductive oxide layer had a thickness of 320 nm. When the thus-obtained 320 nm thick amorphous ITO film was heat-annealed, the amorphous ITO film curled up and cracked, resulting in failure in producing a usable heater.

As can be seen from Table 2, the comparison between the results of the energization tests conducted on the heaters according to the examples and the result of the energization test conducted on the heater according to Comparative Example 1 suggests that setting (Rₑ₁+Rₑ₂)/RA to 45% or less is advantageous from the viewpoint of suppressing uneven spatial distribution of the amount of heat generation in a heating element. Further, the comparison between the results of the energization tests conducted on the heaters according to the examples and the result of the energization test conducted on the heater according to Comparative Example 2 suggests that setting the specific resistance of the material forming a transparent conductive oxide layer 20 to 1.4×10⁻⁴ to 3.0×10⁻⁴ Ω·cm is advantageous from the viewpoint of increasing the amount of heat generation achieved by a heater. Still further, the comparison between the results of the energization tests conducted on the heaters according to the examples and the result of the energization test conducted on the heater according to Comparative Example 3 suggests that setting the thickness of a transparent conductive oxide layer 20 in the range from 20 to 250 nm is advantageous from the viewpoint of preventing the occurrence of cracking.

TABLE 1

| | | | Transparent conductive oxide layer | | | | | Power supply electrode | | | |
|---|---|---|---|---|---|---|---|---|---|---|---|
| | Substrate | | | Specific | | Sheet | Carrier | | Specific | | |
| | | Thickness | | resistance | Thickness | resistance | density | | resistance | Width | Thickness |
| | Material | [μm] | Material | [Ω · cm] | [nm] | [Ω/sq] | [×10²⁰cm⁻³] | Material | [Ωm] | [mm] | [μm] |
| Ex. 1 | PEN | 100 | ITO | 2.0 x 10⁻⁴ | 50 | 40 | 13 | Cu | 1.7 x 10⁻⁶ | 2 | 20 |
| Ex. 2 | PEN | 100 | ITO | 2.0 x 10⁻⁴ | 50 | 40 | 13 | Cu | 1.7 x 10⁻⁶ | 2 | 20 |
| Ex. 3 | PEN | 100 | ITO | 2.0 x 10⁻⁴ | 50 | 40 | 13 | Cu | 1.7 x 10⁻⁶ | 2 | 20 |
| Ex. 4 | PEN | 100 | ITO | 2.0 x 10⁻⁴ | 200 | 10 | 13 | Cu | 1.7 x 10⁻⁶ | 2 | 20 |
| Ex. 5 | PEN | 100 | ITO | 2.0 x 10⁻⁴ | 35 | 57 | 13 | Cu | 1.7 x 10⁻⁸ | 2 | 20 |
| Ex. 6 | PEN | 100 | ITO | 2.0 x 10⁻⁴ | 120 | 17 | 13 | Cu | 1.7 x 10⁻⁶ | 2 | 20 |
| Ex. 7 | PEN | 100 | ITO | 2.0 x 10⁻⁴ | 50 | 40 | 13 | Ni | 7.0 x 10⁻⁶ | 2 | 20 |
| Ex. 8 | PEN | 100 | ITO | 2.0 x 10⁻⁴ | 50 | 40 | 13 | SnPb alloy | 1.5 x 10⁻⁵ | 2 | 20 |
| Ex. 9 | PEN | 100 | ITO | 2.0 x 10⁻⁴ | 50 | 40 | 13 | Cu | 1.7 x 10⁻⁸ | 2 | 2 |
| Comp. | PEN | 100 | ITO | 2.0 x 10⁻⁴ | 50 | 40 | 13 | silver-containing | 8.5 x 10⁻⁵ | 2 | 20 |
| Ex. 1 | | | | | | | | paste | | | |
| Comp. | PEN | 100 | ITO | 8.0 x 10⁻⁴ | 50 | 160 | 4 | Cu | 1.7 x 10⁻⁸ | 2 | 20 |
| Ex. 2 | | | | | | | | | | | |
| Comp. | PEN | 100 | ITO | 8.0 x 10⁻⁴ | 320 | 25 | 4 | Cu | 1.7 x 10⁻⁸ | 2 | 20 |
| Ex. 3 | | | | | | | | | | | |

TABLE 2

| | Shape of heater | | | | | | | |
|---|---|---|---|---|---|---|---|---|
| | Length L of | | Electric resistance | | | | | |
| | contact surface | | | Electric | | | | |
| | between each | | Sum of electric | resistance | | | | |
| | power supply | | resistances of | of transparent | | | | Evaluation |
| | electrode and | Distance W | power supply | conductive oxide | | Heater properties | | of crack |
| | transparent | between power | electrodes in | layer between | | Highest value | Lowest value | resistance |
| | conductive | supply | longitudinal | power supply | | of temperature | of temperature | (presence |
| | oxide layer | electrodes | direction | electrodes | (Rₑ₁ + Rₑ₂)/Rs | rise rate | rise rate | or absence |
| | [mm] | [mm] | Rₑ₁ + Rₑ₂ [Ω] | Rs [Ω] | [%] | [°C./min.] | [°C./min.] | of cracks) |
| Ex. 1 | 60 | 20 | 0.051 | 13.3 | 0.38 | 90 | 90 | absent |
| Ex. 2 | 100 | 20 | 0.086 | 8.0 | 1.06 | 90 | 89 | absent |
| Ex. 3 | 500 | 20 | 0.43 | 1.6 | 26.56 | 90 | 70 | absent |
| Ex. 4 | 100 | 100 | 0.086 | 10.0 | 0.86 | 72 | 71 | absent |
| Ex. 5 | 100 | 20 | 0.085 | 11.4 | 0.74 | 63 | 63 | absent |
| Ex. 6 | 100 | 20 | 0.086 | 3.3 | 2.56 | 216 | 211 | absent |
| Ex. 7 | 100 | 20 | 0.35 | 8.0 | 4.37 | 90 | 86 | absent |
| Ex. 8 | 100 | 20 | 0.75 | 8.0 | 0.38 | 90 | 82 | absent |
| Ex. 9 | 100 | 20 | 0.85 | 8.0 | 10.63 | 90 | 81 | absent |
| Comp. | 100 | 20 | 4.3 | 8.0 | 53.13 | 90 | 55 | absent |
| Ex. 1 | | | | | | | | |
| Comp. | 100 | 20 | 0.085 | 32.0 | 0.27 | 23 | 22 | absent |
| Ex. 2 | | | | | | | | |
| Comp. | 100 | 20 | 0.086 | 5.0 | 1.70 | 144 | 142 | present |
| Ex. 3 | | | | | | | | |

1. A heater comprising:
a substrate;
a transparent conductive oxide layer that is disposed on the substrate;
a first power supply electrode that is electrically connected to the transparent conductive oxide layer and extends in a particular direction; and
a second power supply electrode that is electrically connected to the transparent conductive oxide layer and extends in the particular direction while being spaced apart from the first power supply electrode, wherein
a ratio of a sum of an electric resistance of the first power supply electrode in the particular direction and an electric resistance of the second power supply electrode in the particular direction to an electric resistance of the transparent conductive oxide layer between the first power supply electrode and the second power supply electrode is 45% or less, and
the transparent conductive oxide layer has a thickness from 20 to 250 nm and is formed of a material having a specific resistance from 1.4×10⁻⁴ to 3.0×10⁻⁴ Ω·cm.

2. The heater according to claim 1, wherein a material forming the first power supply electrode has a specific resistance of 4×10⁻⁵ Ω·m or less, and a material forming the second power supply electrode has a specific resistance of 4×10⁻⁵ Ω·m or less.

3. The heater according to claim 1, wherein the material forming the first power supply electrode is a metal material, and the material forming the second power supply electrode is a metal material.

4. The heater according to claim 1, wherein the first power supply electrode has a thickness of 1 μm or more, and the second power supply electrode has a thickness of 1 μm or more.

5. The heater according to claim 1, wherein a material forming the transparent conductive oxide layer contains indium oxide as a main component.

6. The heater according to claim 1, wherein a carrier density of the transparent conductive oxide layer as determined by Hall effect measurement is 6.0×10²⁰ cm⁻³ or more.

7. The heater according to claim 1, wherein the substrate is flexible.

8. A heater-equipped article comprising:
a molded body including an adherend surface;
a pressure-sensitive adhesive layer that is in contact with the adherend surface; and
the heater according to claim 1, the heater being in contact with the pressure-sensitive adhesive layer and attached to the molded body with the pressure-sensitive adhesive layer.
